(19) United States
(12) Patent Application Publication
(10) Pub. No.: US 2025/0018793 A1
(43) Pub. Date: Jan. 16, 2025

(54) Externally-Visible Electric Vehicle State of Charge and Charging Status Information Display Device and Method

(71) Applicant: Benjamin Jones, Berkeley, CA (US)

(72) Inventor: Benjamin Jones, Berkeley, CA (US)

(21) Appl. No.: 18/765,877

(22) Filed: Jul. 8, 2024

Related U.S. Application Data
(60) Provisional application No. 63/513,285, filed on Jul. 12, 2023.

(51) Int. Cl. B60K 35/22; B60L 53/62

(52) U.S. Cl. CPC B60K 35/22; B60L 53/62; B60K 2360/169; B60K 2360/182; B60K 2360/589; B60L 2250/16

(57) ABSTRACT

An electronic device situated in an electric vehicle displays the precise state of charge (SOC) and charging status of the vehicle such that this information is visible from a substantial distance outside the vehicle while the vehicle is charging, connected to a charging station, or idle after disconnection from a charging station. The displayed information is easily comprehensible to a driver in an approaching electric vehicle who is interested in using the charging station, allowing the approaching driver to quickly determine if the charging station is available for use, or how soon it may be available. A method for accessing and displaying information regarding an electric vehicle charging session, allowing for a constant display of charging information outside of the electric vehicle.

### PRIORITY

This application claims domestic benefit from pending application No. 63/513,285, filed Jul. 12, 2023, and incorporated by reference.

### FIELD OF INVENTION

The invention is in the field of electric vehicle charging systems and more specifically, notification of charge status.

### BACKGROUND

An electric vehicle is an automobile that has one or more electric motors and a high-voltage battery, or other electrical energy storage means, that is charged from an external electrical power source and that provides the stored energy to the one or more electric motors to propel the vehicle. For the purposes of this disclosure the term “electric vehicle” (EV) encompasses both a battery electric vehicle (BEV), which uses electricity as its sole energy source, and a plug-in hybrid electric vehicle (PHEV), which also has a combustion engine that may assist the one or more electric motors in propulsion and/or may act as a generator to recharge the battery during driving.

An EV also has one or more charging ports configured to accept a charging plug: a connector situated at the end of an electrical cable where said cable transfers electricity from the external power source to the vehicle. The cable is a component of, or in some instances detachably connected to, the Electric Vehicle Supply Equipment (EVSE). The EVSE, herein referred to as a “charging station,” is the electrical equipment required to safely transfer the energy to the vehicle from the external source such as a utility grid. A charging station may be an alternating current (AC) charging station, providing AC electricity to a battery charger on board the vehicle, the on-board charger then rectifying the electricity to direct current (DC) to charge the battery. A charging station may also be a DC charging station, providing DC electricity to the vehicle battery, bypassing the on-board battery charger. A DC charging station typically provides much higher power than an AC charging station, thereby charging a vehicle more quickly, and it performs any necessary rectification to direct current, thereby acting as the battery charger instead of the charger on board the vehicle.

Residential charging stations are typically AC while charging stations at workplaces and in public locations may be either AC or DC. Locations with short expected dwell times, such as highway rest areas and grocery stores, often have higher power DC charging stations, which can substantially recharge a typical EV in fewer than 30 minutes, while locations with longer expected dwell times, such as workplaces, hotels, parking garages, and shopping malls, often have lower power AC charging stations, which can substantially recharge a typical EV over the course of several hours.

A typical EV is configured to allow charging at AC and DC charging stations and the charging process proceeds in a very similar manner regardless of the type of charging station. A “charging session” begins when the driver connects the charging plug to the vehicle charging port, performs any payment, authorization, or activation of the charging station if such is required for that specific station, and electricity starts to flow to the vehicle. The charging session may end normally due to several reasons including when one of the following occurs: the vehicle battery is fully charged, the vehicle stops the charging process because the battery has stored an amount of energy below a full charge that was previously specified by the user and stored in the vehicle's on-board computer, the charging station stops transferring energy for example due to the expiration of a time limit, the user instructs the vehicle or charging station to stop charging for example by pressing a stop button, or the user unplugs the vehicle during charging so the vehicle can be driven. The charging session may also end prematurely due to an unexpected reason such as an error occurring that interrupts the charging process, for example the power supplied from the utility grid to the charging station shutting off, or another user unplugging the vehicle before charging has finished.

The “charging status” of an EV describes whether the vehicle is charging and includes the various possible stages of the charging session, such as charging not started, charging active, charging stopped, charging finished, and charging error.

While charging the vehicle, electrical energy transferred from the external source accumulates in the battery. The state of charge (SOC) of the vehicle battery is the amount of energy presently stored in the battery, represented by a percentage of the total energy capacity of the battery, from 0 to 100. A typical EV is configured to display the SOC to the driver on the vehicle dashboard while driving, informing the driver of how much energy is available as a proportion of a full charge. The displayed SOC may not be identical to the true SOC of the battery; the vehicle is typically configured to prevent usage of a small portion of the capacity at both the lower and upper ends of the battery SOC scale for the purposes of maintaining battery longevity, such that the usable energy capacity of the battery is less than the total energy capacity. While the displayed SOC ranges from 0% to 100%, this may represent a subset of the true battery SOC, where for example the vehicle allows only a range of 10% to 95% of the true SOC to be used. Only the usable capacity is of day-to-day importance to the vehicle operator and for the purposes of this disclosure all subsequent references to “SOC” represent the SOC value as presented to the driver such as via a dashboard gauge and not the true SOC of the battery.

An EV may have, in place of or in addition to its at least one charging port, a wireless charging receiver that allows for inductive charging of the vehicle, typically installed on the underside of the vehicle. Rather than the conductive charging facilitated by a cable and plug, inductive charging transfers electrical energy from the charging station to the vehicle without a physical electrical connection between the two. An inductive charging station may be engaged when a vehicle parks over the transmitting coil and its receiving coil axially aligns with the transmitter, allowing energy transfer to begin. The charging station is thus occupied when a vehicle is located in the parking spot that houses the transmitter unit, regardless of whether charging is active. No other vehicle can use the charging station until the first vehicle vacates the spot, whereas in the case of a conductive charging station, a vehicle that has finished charging may be unplugged and the charging cable may be of sufficient length to be plugged into a second adjacently parked vehicle, thereby allowing use of the charging station before the first vehicle vacates its spot. Throughout this disclosure it is understood that any plug locking mechanism that may be present on a vehicle is disengaged when charging has stopped or finished, allowing such unplugging to occur.

As used herein, the phrase “connected to a charging station,” or similar phrasing conveying such a condition, denotes the existence of at least one of a conductive connection between the vehicle and charging station, such as a charging plug attached to the vehicle charging port, and an inductive coupling between the vehicle and charging station, such as a transmitter/receiver coil pair used for inductive charging. Thus, while reference is made herein to a vehicle being “connected to a charging station,” this descriptor also includes a vehicle occupying a wireless charging spot. In addition, the terms “plug” and “connector,” “plug in” and “connect,” and “unplug” and “disconnect,” may be used interchangeably herein.

While an EV is connected to a charging station, the driver of the vehicle often wants to know various information about the charging session, such as the charging status and SOC, so they know when the vehicle has reached a desired SOC, when the vehicle is fully charged, if any problems have occurred during charging, if the vehicle has been unplugged, and the like. If the driver sits inside the vehicle, such information is typically available via the vehicle dashboard with the vehicle powered to an “accessory” mode. Remaining in the vehicle is not always practical and during most charging sessions the driver leaves the vehicle unattended at the charging station. The driver may be able to access information about the charging session remotely using an Internet-based connection via a mobile phone application or a website. A vehicle may be configured with an on-board communication device that may transmit vehicle data over the Internet, such as via a cellular network, that the driver may then access remotely via said means. This may provide the driver with detailed charging information such as the SOC, charging status, plug connection status, charging power, and estimated charging time remaining. This information is accessible only to the driver as the owner and/or operator of the vehicle.

The charging station may also be configured with a communication device that may transmit charging session data over the Internet, such as via a cellular network, that the driver may then access remotely via said means. This data provided via a charging station may be significantly less detailed than that provided via a vehicle. It may include information known to the charging station, such as charging power and whether charging is active. It may also include, in certain instances, limited information provided by the vehicle to the charging station via communication over the charging cable. A DC charging station is configured to communicate in a sophisticated manner, for example via power line communication (PLC), with the connected vehicle over the charging cable and therefore has access to some detailed vehicle data such as SOC and charging time remaining. This detailed vehicle data may then be communicated by the charging station to the remote user. Most existing AC charging stations are configured to communicate with the connected vehicle over the charging cable in a simplified manner using only a pulse-width modulation (PWM) signal, which does not allow the charging stations to access detailed vehicle data such as SOC. Although sophisticated communication between the charging station and the vehicle is possible with an AC charging station, the present implementation of this capability is limited. Thus, for the purposes of this disclosure, it is understood that an AC charging station has no access to detailed vehicle data. Therefore, no detailed vehicle data is communicated by the charging station to the remote user. Finally, whether provided by a DC or an AC charging station, this information is accessible remotely only by the driver as the present user of the charging station.

Although the vehicle driver has various potential means to access charging session information, there are many instances where people other than the driver, in particular other EV drivers, would greatly benefit from this information.

While an EV is connected to a charging station, it is very helpful for a person at the charging location to be able to determine the SOC and charging status of the vehicle from outside the vehicle. This is especially important in a setting where charging stations are used by many drivers, such as public and workplace charging locations. In these settings a driver who arrives wanting to charge but finds the charging stations occupied needs information about the vehicles presently using the charging stations so they can make a judgement about whether they will be able to charge soon, or if they should try another location or return at another time.

In addition, a charging location may have multiple parking spaces for each charging station, wherein a charging cable may be of sufficient length to connect to vehicles parked in several adjacent parking spots. This may be more likely the case with AC charging stations, where vehicles are often left unattended for longer periods of time. This infrastructure arrangement allows a second vehicle to use the charging station after a first vehicle is finished without having to wait for the first vehicle to be moved. If an approaching driver can easily ascertain the charging status and SOC of each of a plurality of presently connected vehicles, the approaching driver can choose an open parking space that will allow the soonest possible access to a charging station, and the driver can be certain when a connected vehicle has finished charging and can be unplugged so the driver can use the charging station.

Approaches exist to attempt to provide this charging session information. Externally-visible SOC and charging status indicators are known and exist on most contemporary EVs. However, the indicators are often very simple, using one or more lights in a variety of implementations to provide imprecise, and often insufficient, charging information to the exterior of the vehicle.

Some vehicles employ a single light that may pulse, blink, and/or illuminate in different colors to convey charging statuses such as active charging, an error, or a stoppage, and in some instances, to convey approximate SOC. Since there is no standardization of what different colors, brightnesses, or blinking patterns mean, this results in a lack of clarity and potential confusion for an observer. Different vehicles employ different illumination strategies, for example blinking a green light a certain number of times to denote an approximate SOC while charging, pulsing a green light to indicate active charging but without any SOC indication, blinking a green light while charging and illuminating a solid green light when finished, and illuminating a solid green light while charging and blinking a green light when finished.

Some vehicles employ a series of a few adjacent lights that may illuminate consecutively while charging such that each additional illuminated light represents a fractional increase in the SOC. Typically the most recently illuminated light in the series also blinks to indicate active charging. In order to determine the approximate SOC, an observer must count the number of illuminated lights and unilluminated lights and calculate the fractional percentage. The result is a range of values in which the SOC resides, providing imprecise information. For example, a series of three lights represents 0%-33%, 34%-67%, and 68%-100% SOC as each consecutive light illuminates during a charging session, wherein at 35% SOC the same two lights illuminate as at 65% SOC.

These light-based indicators also do not always illuminate for the entire duration of the charging session, and may turn off when a predefined amount of time has elapsed after their activation. If they do illuminate for the entire charging session, they also may only remain illuminated for a brief period after the charging session has ended. These behaviors prevent the light-based indicators from conveying useful information to an observer in such situations.

Finally, the small size and location of the lights, which are often situated on top of the dashboard near the windshield or next to the charging port on the side of the vehicle, require an observer to be very close to the vehicle in order to see them.

Improvements have been proposed to light-based indicator approaches to increase overall visibility and/or precision of the SOC represented. Numerous disclosures describe the use of headlights, tail lights, and/or turn signal lights to indicate charging statuses and/or SOC, such as U.S. Pat. Nos. 9,283,888, 9, 818,268, and 10,746,575, and U.S. Patent Applications 2012/0133282 and 2014/0253306, all of which attempt to increase visibility, at least when approaching or viewing a vehicle from certain angles. U.S. Pat. No. 11,173,805 discloses a center high-mounted rear brake light assembly that doubles as such an indicator, wherein the many individual lighting elements of the wide assembly allow for the conveyance of smaller ranges of SOC values, while U.S. Pat. No. 11,288,902 similarly discloses a wide, front- or rear-mounted light bar, which allows for more incremental SOC representation. U.S. Pat. Nos. 8,487,752 and 9,340,119 disclose roof-mounted antennas that incorporate light-based indicators to increase visibility.

Further improvements beyond light-based indicators have also been proposed, since the lights are not well-suited for quickly providing an accurate SOC value or a clear, comprehensible charging status to an external observer. As is the case with the SOC presented on the dashboard to the driver inside the vehicle, the best format in which to present the SOC to a person outside the vehicle is a numerical value. Several disclosures include presentation of a numerical SOC value to an external observer, but these numbers are either small in size and thus visible only to a person standing in close proximity to the vehicle (U.S. Pat. Nos. 5,757,595, 8,125,180, 8,179,245, 9,789,783, 10,391,923 and U.S. Patent Application 2010/0238006), or are not always presented for the duration of the charging session (U.S. Pat. No. 10,802,575). When an EV is connected to a charging station, especially when it is not actively charging, clearly conveying the charging status to a person outside the vehicle is important so a person wanting to use the charging station can act accordingly. The best format in which to present the charging status is a word-based message. Several disclosures include presentation of word-based charging statuses to an external observer, but these messages are either small in size and thus visible only to a person standing in close proximity to the vehicle (U.S. Pat. Nos. 8,179,245 and 10,308,131 and U.S. Patent Applications 2010/0230193 and 2010/0238006), are not always presented for the duration of the charging session (U.S. Pat. No. 10,802,575), or present a limited subset of only one or two statuses (U.S. Pat. Nos. 10,604,066 and 11,160,152).

Some of the aforementioned disclosures also offer improved visibility by increasing the distance from which the charging information may be visible, such that an observer does not need to be next to the vehicle. However, each disclosure has significant shortcomings: imprecise SOC presentation via a series of incremental graphical bars (U.S. Pat. No. 10,604,066), limited information presentation showing only two statuses and no SOC (U.S. Pat. No. 11,160,152), and limited presentation duration (U.S. Pat. No. 10,802,575).

Another possible source of charging session information for a person outside the vehicle is the charging station. Most charging stations have some means of indicating at least a basic charging status, such as one or more lights. The colors and illumination patterns of the lights vary by charging station manufacturer and model and, as with light-based charging indicators mounted on a vehicle, there is no standardization that correlates a specific light color or behavior with a specific charging status, leading to a similar lack of clarity and possible confusion for an observer.

Some charging stations have a display screen that can present more detailed information. DC charging stations, in particular, are often configured with a display screen that shows vehicle SOC as a number. AC charging stations are not able to show vehicle SOC since, as previously described, communication of specific vehicle information such as SOC to the charging station over the charging cable is limited to DC charging and does not occur while AC charging. An AC charging station configured with a screen may show a few charging statuses, such as “Charging” or “Error.” Lacking access to vehicle SOC, the station cannot accurately show when a vehicle is fully charged, only when a connected vehicle is not charging, which may take the form of various phrases. A DC charging station configured with a screen, in addition to showing SOC, may similarly use words on the screen to convey statuses, such as “Initializing,” “Communicating with Vehicle,” “Error,” and “Stopped.” Since the DC charging station has access to vehicle SOC, the station may also show on the screen when the vehicle is fully charged.

While the charging station screens may display useful information, the screens are typically small, especially those employed by AC charging stations, and the characters displayed thereon are also small, being legible from a maximum distance of only a few feet. In addition, the content presented on the screen may not always include the important charging information, as the charging station is often configured to either change the content back to a default “welcome” graphic, show a screen saver animation, show promotional material, or cycle through a combination of these or other various content. Furthermore, due to the typical location of a charging station at the front of a parking spot, with a connected vehicle parked between it and an approaching vehicle or observer on foot, view of a charging station screen is usually partially or completely obstructed by the vehicle connected to the charging station. In some instances the charging station may be situated such that any screen that may exist is facing away from the connected vehicle and therefore not even facing the direction from which another vehicle typically approaches. All of these factors require an observer, who is attempting to ascertain from the charging station the SOC and/or charging status of the presently connected vehicle, to be positioned in close proximity to the charging station, often necessitating the observer exit their vehicle and approach on foot, and may further require the observer to interact with the screen in order to access the desired information if such information is not presently displayed. As mentioned, that information does not include SOC or detailed charging statuses if the station is an AC charging station. Finally, for both AC and DC charging stations, the vehicle must still be connected to the charging station for any information presented on a station screen, or conveyed via station indicator lights, to accurately correspond to the vehicle. When the vehicle is unplugged, the station screen and/or indicator lights reset and no longer show any information about the vehicle, leaving a subsequent observer with no information from the charging station.

It should be apparent from this discussion that none of the prior art is sufficient in conveying to an external observer at a substantial distance the SOC and charging status of an EV in a clear, comprehensible, precise, and user-friendly manner.

### SUMMARY

The present disclosure provides a device and its controlling method that significantly improve this situation. Embodiments of the present invention connect to an on-board communication network of an EV and, while the vehicle is charging, display the SOC of the vehicle's battery in numerical form, as well as display clearly decipherable charging status information using words at all other times of a charging session, displaying it in such a manner that the information is viewable by an observer outside the vehicle positioned at a distance of up to at least 25 feet. Embodiments of the present invention may be built into the vehicle or may be an add-on accessory and may display the information through a window, such as a windshield and/or back window, via a screen inside the vehicle, or may display the information on a window, such as a windshield and/or back window, via projection. Embodiments of the present invention make the information visible and easily comprehensible to a driver in an approaching EV who is interested in using the charging station occupied by the subject vehicle.

Disclosed embodiments provide a solution to the previously described limitations of existing SOC and charging status indicators and display means. By displaying SOC and charging status in a standardized manner that uses numbers and words, embodiments of the present invention enable the information to be immediately understandable to an observer without requiring the observer to have any prior knowledge of the custom way in which a specific vehicle may show such information, improving the common present situation where an observer must count the number of times a light blinks, count the number of lights or graphical bars illuminated in a series, or try to interpret what a specific light color or behavior might signify.

By displaying SOC and charging status in a large size and by being situated so as to outwardly face towards approaching vehicles, embodiments of the present invention enable the information to be visible and legible to an observer positioned at a distance of up to at least 25 feet, in particular one who is approaching in a second vehicle and is interested in using the charging station. Embodiments of the present invention thereby improve the common present situation where an observer is unable to view the charging information of a vehicle connected to a charging station while approaching in a second vehicle and instead must be positioned in close proximity to the first vehicle, often standing near the charging port or the dashboard, in order to view any charging information indicator that may exist on the vehicle, or in close proximity to the charging station in order to view any charging information that may be presented via a screen on the charging station.

By displaying SOC using the numerical value, embodiments of the present invention also provide a precise SOC to an observer, improving the common present situation where an SOC indicator, composed of a series of lights or a single light that blinks a certain number of times, provides only a discrete range in which the present SOC value resides, resulting in an imprecise value conveyed to the observer. For example, at an SOC value of 97%, a three-light indicator (with ranges of 0%-33%, 34%-67%, and 68%-100%) shows this SOC the same as if it were 68% and a five-blinking-stage light indicator (with ranges of 0%-20%, 21%-40%, 41%-60%, 61%-80%, and 81%-100%) shows this SOC the same as if it were 81%, while embodiments of the present invention show this as the exact SOC of 97%. Showing a precise SOC allows an observer to better determine how close the vehicle is to finishing its charging session, and therefore how soon the charging station may be available.

By displaying charging status using specific descriptions, embodiments of the present invention also provide more information to an observer, improving the common present situation where a charging status indicator composed of one or more lights displays only a color, blinking pattern, or a combination thereof to convey limited information about the status. In particular, when a vehicle connected to a charging station is not actively charging, there are several possible reasons, and the conveyance of the correct reason is typically ambiguous as presented by the current state of the art. In this scenario, embodiments of the present invention display a charging status that explains whether the charging session has not yet begun and the vehicle is waiting for it to start, the charging session has stopped before finishing successfully due to an interruption, or the vehicle is fully charged (or has reached a target charging SOC previously set by the driver of the vehicle) and the charging session is complete. Showing the specific charging status allows an observer to easily determine whether the charging station is available for use and therefore if the vehicle can be disconnected.

By continuing to display the charging status and/or SOC after charging has been interrupted or has finished while the vehicle is still connected to the charging station, and also after the vehicle has been disconnected from the charging station until the vehicle moves, embodiments of the present invention enable an observer to continue to ascertain the status of the vehicle until the driver moves the vehicle, improving the common present situation where a charging status or SOC indicator deactivates soon after interruption or completion of the charging session, and also deactivates immediately upon disconnection of the vehicle from the charging station, resulting in no information provided to an observer.

Embodiments of the present invention are situated in a vehicle and connected to the on-board vehicle communication network, enabling them to provide detailed charging information in more situations than what a charging station may provide via a screen or indicator lights. As previously described, while a DC charging station may display vehicle SOC and charging status via a screen on the charging station, an AC charging station is not able to show vehicle SOC and it is able to show only limited information about the vehicle charging status. Embodiments of the present invention display detailed charging information, including SOC and charging status, regardless of the type of charging station to which the vehicle is connected, whether DC or AC. Embodiments of the present invention also display charging information for the entirety of the charging session, improving the common present situation where the content on a charging station screen changes to show other information unrelated to the charging session. As previously described, embodiments of the present invention also continue to display the charging status and/or SOC after the vehicle has been disconnected from the charging station until the vehicle moves, improving the common present situation where disconnecting the vehicle from the charging station clears any information about the vehicle that may have been presented via a charging station screen or indicator lights.

Some embodiments of the present invention may be integrated into the vehicle during design and manufacturing, being affixed inside the passenger compartment or affixed to, or part of, an exterior component of the vehicle. Other embodiments of the present invention may take the form of a self-contained vehicle accessory device configured to detachably connect to the on-board communication port of an existing electric vehicle, thereby adding the herein described features to a vehicle that lacks them, and configured to allow for placement of the device in various locations throughout the interior of the vehicle to maximize external visibility of the displayed charging information based on orientation of the vehicle at a specific charging location. Some embodiments of the present invention may include more than one instance of a display in a vehicle, increasing the number of directions from which the displayed charging information may be viewable by an external observer. Some embodiments of the present invention, when in an inactive state, may have a resting position that is recessed, rotated flat, folded down, collapsed, hidden, or otherwise situated to avoid visual obstruction to the operator of the vehicle while driving and, when the vehicle is first connected to a charging station, may transition to an active state by automatically moving into a position that is visible from outside the vehicle.

Some embodiments of the present invention may allow the vehicle operator to select, via an in-vehicle or on-device settings menu, whether the display should be inactive at one or more charging locations, such as the driver's home, and may retain said location-based information so as not to activate the display during any charging session that occurs at one of the specified locations.

Some embodiments of the present invention may display in numerical form, in addition to or in place of the SOC, at least one of the charging time remaining and the instantaneous charging power while the vehicle is actively charging.

Although emphasis has been placed on the importance of providing detailed charging information to an external observer who is not the driver of the subject vehicle, embodiments of the present invention also provide many of the same benefits to the driver. The driver may not have remote access to charging session information, which may occur if neither the vehicle nor the charging station is configured with a communication device to transmit data over the Internet, such as via a cellular network, or if the driver does not presently possess a device from which to remotely view any such information, and the driver must therefore rely on external indicators to ascertain the SOC and charging status when away from the vehicle. While the driver has the advantage of being able to enter the vehicle and check such information on the interior instrument cluster, it is much more convenient to view the information from a distance outside the vehicle, just as an approaching second driver would. Embodiments of the present invention enable a driver to easily determine if the vehicle has finished charging and therefore can be disconnected from the charging station and moved, or how close the charging session is to finishing if the vehicle is still charging, or if there has been an interruption in the charging session that requires attention. In addition, by clearly displaying if a charging session has not started after connecting the vehicle to a charging station, embodiments of the present invention help inform the driver to take any necessary measures to make sure that charging begins, if such is the expected behavior, before leaving the vehicle unattended.

Additional features of the present invention will become apparent to those skilled in the art upon consideration of illustrative embodiments that exemplify the best way of carrying out the disclosure.

### BRIEF DESCRIPTION OF THE DRAWINGS

FIGS. 1A-1F are perspective views of exemplary externally-visible EV SOC and charging status information display devices in accordance with embodiments of the present invention.

FIG. 2 illustrates an EV charging location with each EV connected to a charging station and each EV incorporating an externally-visible EV SOC and charging status information display device in accordance with embodiments of the present invention.

FIG. 3 is a block diagram of a charging station, an EV, and an externally-visible EV SOC and charging status information display device in accordance with embodiments of the present invention.

FIG. 4A schematically illustrates a method of controlling an externally-visible EV SOC and charging status information display device, in accordance with embodiments of the present invention. FIGS. 4B-4F illustrate the visual outputs of such a display device, in accordance with embodiments of the present invention.

### DETAILED DESCRIPTION

The figures and descriptions of the present disclosure may be simplified to illustrate the aspects relevant for a clear understanding of the devices, systems, and methods described herein and may omit, for the purpose of clarity, other aspects that may be present in typical devices, systems, and methods. Those skilled in the art may discern that additional elements and/or operations may be helpful or required to carry out the teachings of this disclosure, but because they are well known in the art, such elements and operations may not be described herein. Nonetheless, it is understood that the present disclosure inherently includes all such elements and operations known to those skilled in the art. The figures are not necessarily drawn to scale and some features may be exaggerated or reduced in order to show the details of specific components. In the figures, reference numbers indicate like or corresponding, though not necessarily identical, elements throughout the several views.

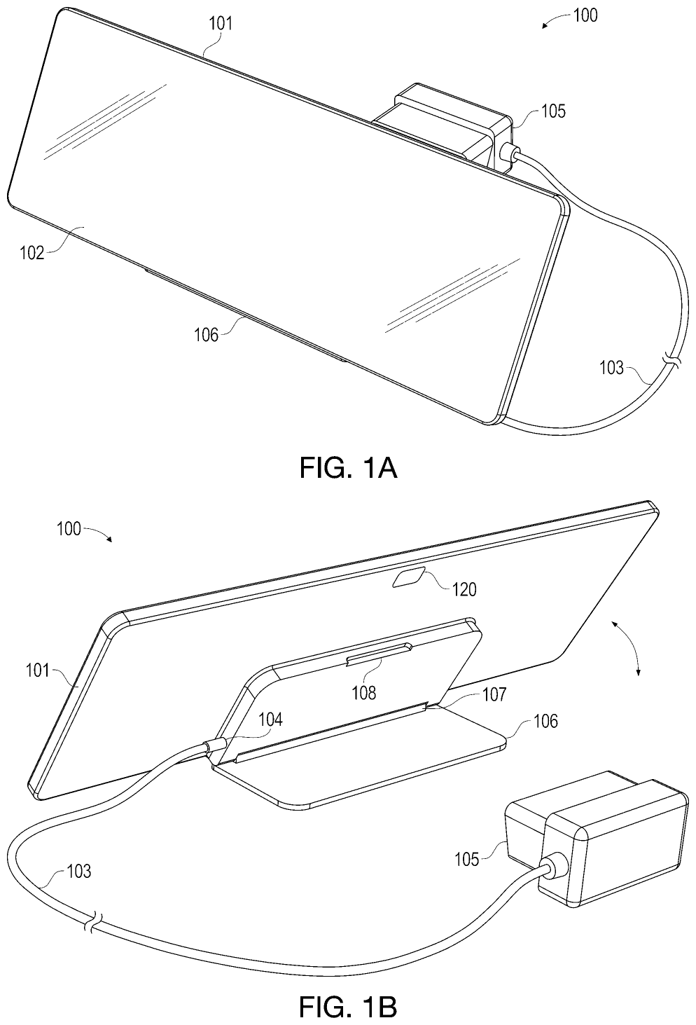

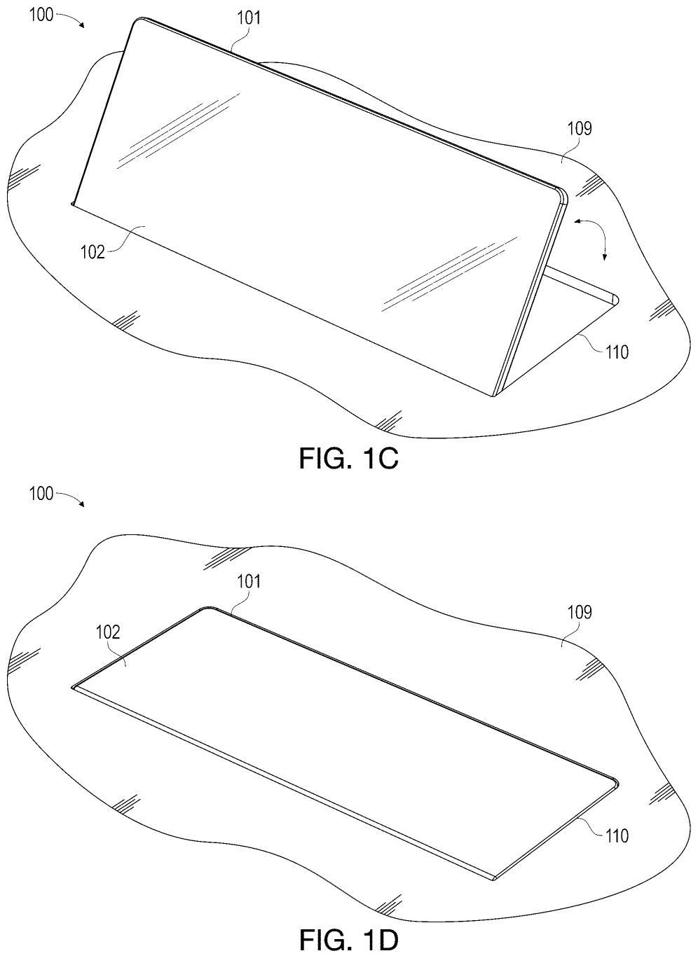

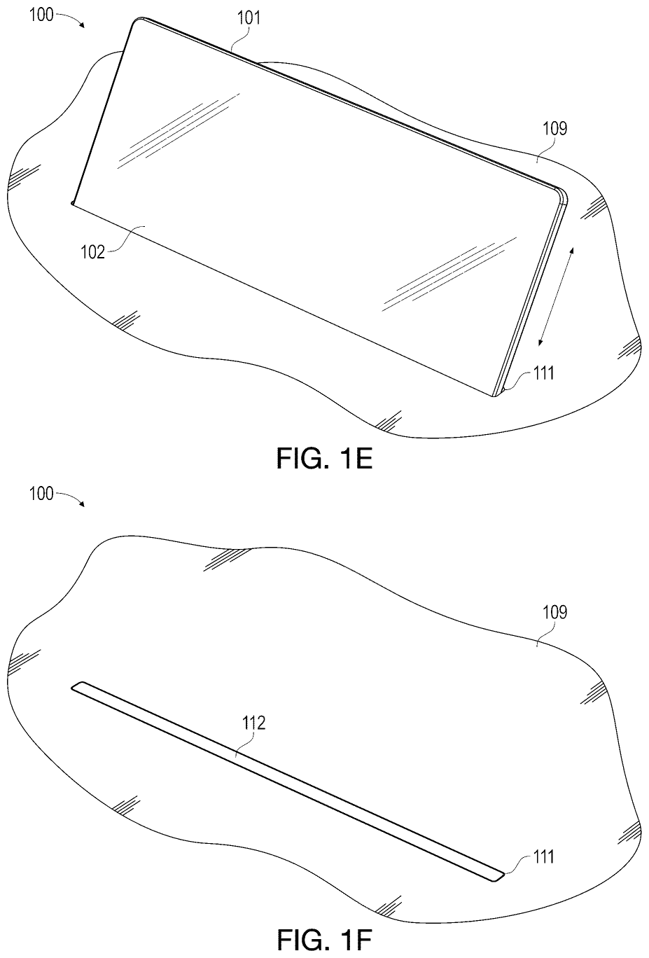

Referring now to FIGS. 1A-1F, in embodiments of the present invention the externally-visible EV SOC and charging status information display device 100 (henceforth referred to as “the device”) consists of a display portion 101 that houses a display screen 102, which employs LCD, LED, digital, or any other display technology capable of rendering alphanumeric characters and graphical symbols. The screen 102 is illuminated for legibility in all ambient lighting conditions, from bright sunlight to complete darkness. As is known in the art, the device 100 may employ an ambient light sensor and may automatically adjust the illumination brightness of the screen 102, based on a signal generated by said sensor, to ensure optimal visibility of the displayed content.

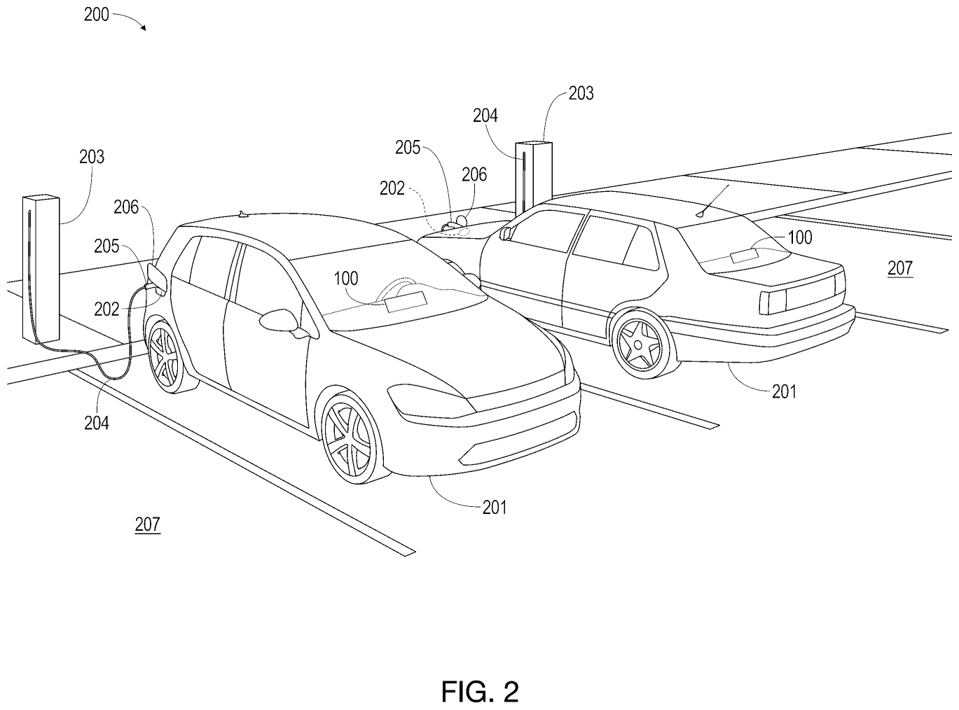

FIGS. 1A-1B show an exemplary embodiment wherein the device 100 is a self-contained vehicle accessory that is not permanently affixed to an electric vehicle 201 (see FIG. 2). The device 100 electrically connects to the vehicle 201 via an electrical cable 103. One end of the cable 103 detachably connects to the device 100 at an input cable receptacle 104. The other end of the cable 103 may terminate in a standard on-board diagnostics (OBD-II) (or equivalent) plug 105 to detachably connect to the on-board diagnostics port in the vehicle 201, or may terminate in another type of connecting means appropriate for detachably connecting to the on-board communication network of the vehicle 201. The cable 103 may be of sufficient length to allow a user to place the device 100 in multiple different locations in the interior of the vehicle 201, in order to optimize external visibility based on the particulars of a charging location layout and the resulting vehicle orientation.

The device 100 contains a base portion 106, attached to the display portion 101 at a hinge 107. The base portion 106, via the hinge 107, is configured to allow the device 100 to collapse to a flat position when the device 100 is inactive, or when active but a flat configuration is desired. A user may rotate the base portion 106 manually (as indicated by the arrow in FIG. 1B) by utilizing a notch 108 in the back of the display portion 101 to initially separate the base portion 106 from the display portion 101. Further embodiments may instead employ one or more internal electric motors or other electromechanical means to rotate the display portion 101 away from the base portion 106 automatically when the device 100 is activated, and to rotate the display portion 101 back towards the base portion 106 automatically when the device 100 is deactivated. Whether rotation occurs manually or automatically, the user may adjust the final angle of rotation for best external visibility. The base portion 106 may rest, or be detachably situated such as via magnetic bond or other repeatably attachable fasteners, on a window-adjacent vehicle surface, such as the dashboard or rear deck, or may detachably affix to a sun visor, roof liner, or other interior component, such that charging information displayed on the screen 102 is visible to an external observer. Depending on the user-selected location of the device 100 inside the vehicle 201, in order for the screen 102 to be visible from outside, the device 100 may be either in an open, rotationally separated position, such as when situated on a dashboard, or a closed, flattened position, such as when attached to a sun visor that is subsequently rotated downwards from the vehicle ceiling.

Further embodiments may have different structural configurations from the one represented in FIGS. 1A-1B to allow the device 100 to be removably mounted in various locations inside the vehicle 201, including to a window face, to the back side of a windshield-mounted rear view mirror, and to an interior trim component, and to allow the device 100 to be adjustably oriented such that the screen 102 is visible from outside the vehicle 201. Embodiments may also be configured to be static, with no movable aspects required for the screen 102 to be externally visible. Further embodiments may use, instead of a display screen, a visual projecting means to display the charging information onto a window face from inside the vehicle 201, such that the information is visible from outside.

Such a self-contained vehicle accessory device, when connected to an existing EV and placed appropriately within the interior, thus adds the externally-visible charging information display capabilities of the present disclosure to a vehicle that may have been manufactured either without any system to show charging information externally or with one of the current systems described previously that conveys ambiguous, imprecise, and/or insufficient charging information to an external observer. Addition of this accessory significantly improves the experience at charging locations for the driver and the drivers of other EVs, for the remainder of the vehicle's service life.

In an alternate embodiment, the device 100 may include a wireless transmitter 120, allowing the device to send the charging information via any of a variety of wireless transmission protocols. The transmitted charging information may include any or all of the information presented in the display portion 101.

FIGS. 1C-1D show another exemplary embodiment wherein the device 100 is built into the vehicle 201 at the time of manufacture, contained within a window-adjacent vehicle surface 109, such as the dashboard or rear deck (shown), or upside down in a sun visor or ceiling panel. The device 100 electrically connects directly to the vehicle 201 via a built-in vehicle wiring harness (illustration omitted), which includes connection to the on-board communication network. When the device 100 activates, the display portion 101 rotates out of a recessed area 110 (as indicated by the arrow in FIG. 1C) to a position such that charging information displayed on the screen 102 is visible to an external observer. When the device 100 deactivates, the display portion 101 rotates back to its resting position inside the recessed area 110 (FIG. 1D).

FIGS. 1E-1F show another exemplary embodiment wherein the device 100 is again built into the vehicle 201 at the time of manufacture, contained within a window-adjacent vehicle surface 109, such as the dashboard or rear deck. The device 100 electrically connects directly to the vehicle 201 via a built-in vehicle wiring harness (illustration omitted), which includes connection to the on-board communication network. When the device 100 activates, the display portion 101 slides out of a recessed area 111 in a generally upward direction (as indicated by the arrow in FIG. 1E) to a position such that charging information displayed on the screen 102 is visible to an external observer. When the device 100 deactivates, the display portion 101 slides in a generally downward direction back to its resting position inside the recessed area 111, where it may be covered by an automatically retracting cover 112 (FIG. 1F).

Further embodiments may use, instead of a display screen, a visual projecting means built into the interior of the vehicle 201 to display the charging information onto at least one window face from inside the vehicle 201, such that the information is visible from outside.

Further embodiments may be realized in other form factors that allow display of the charging information to an external observer and also prevent visual obstruction to a vehicle operator when inactive, such as when the vehicle 201 is being driven. Such embodiments may employ a similar movable aspect to transition between inactive and active states, or may be static with no movable aspects and be positioned in a manner that avoids visual interference.

Further embodiments may comprise a screen built into the exterior of the vehicle 201 at the time of manufacture, integrated with a body panel, bumper, or other exterior component.

Multiple instances of the device 100 may be located in the vehicle 201, increasing the directions from which the displayed information is externally visible. If the vehicle 201 contains only one instance of the device 100, it may be situated in a location that maximizes visibility based on the location of the charging port and, since a driver typically parks an EV with the charging port closest to the charging station, therefore based on the typical orientation of the vehicle 201 during charging. For example, for a vehicle with its charging port in a rear quarter panel, wherein charging typically occurs with the vehicle backed into a parking space, the device 100 may be located at the front of the vehicle, such as on the dashboard. Conversely, for a vehicle with its charging port in a front fender or in the area below the front of the hood, wherein charging typically occurs with the vehicle parked forwards in a parking space, the device 100 may be located at the rear of the vehicle, such as on a rear deck. These configurations maximize the likelihood that the device 100 is viewable by the driver of an approaching vehicle. These configurations also overcome another limitation of many existing and proposed charging indicators wherein the indicator, if it is even visible from a distance, faces a direction opposite that from which another vehicle approaches. For example, a vehicle with its charging port in a front fender that is typically parked forwards in a parking space to charge and that also has a charging indicator light on top of the dashboard typically results in the indicator facing towards the charging station and not towards approaching vehicles.

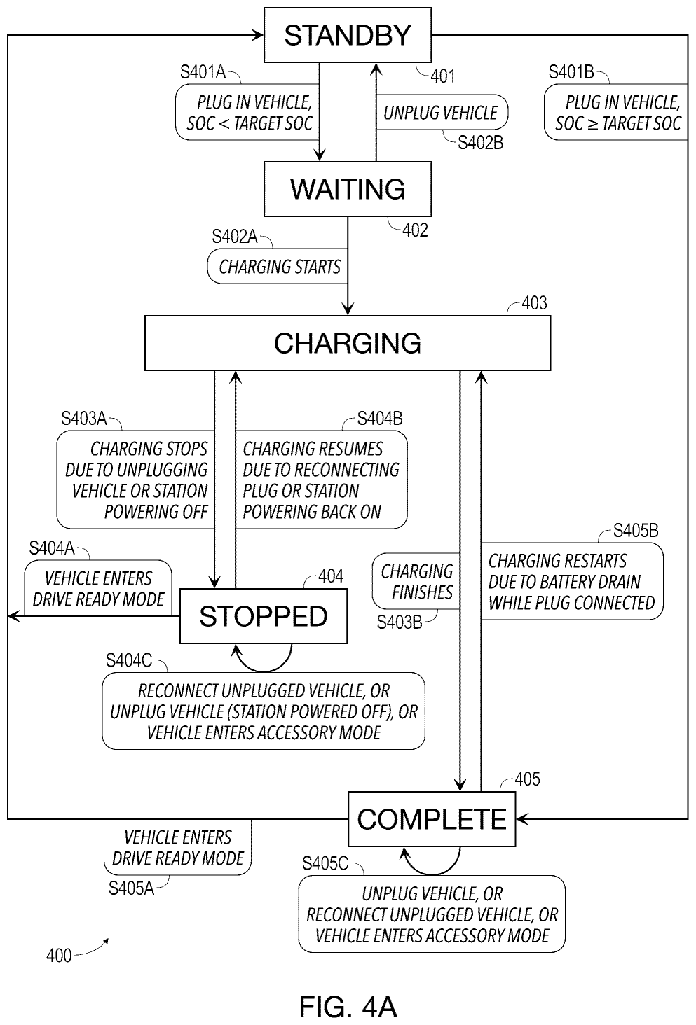

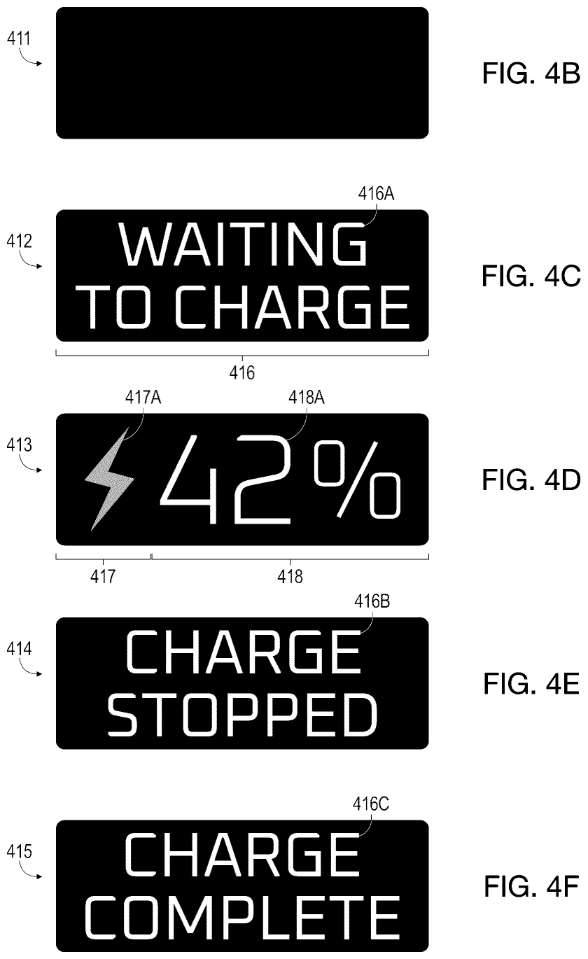

FIG. 2, with continued reference to FIGS. 1A-1F, shows an electric vehicle charging location 200. Each electric vehicle 201 has a charging port 202 and is connected to a charging station 203 via the respective charging cable 204 and its terminating charging connector (“plug”) 205, which detachably connects to the vehicle charging port 202. A charging port door 206 on each vehicle 201 covers the charging port 202 when closed, and allows access for charging when open. While passenger cars are shown, each vehicle 201 may be any type of automobile, including passenger cars (sedans, hatchbacks, coupes, convertibles), SUVs, crossover SUVs, pickup trucks, minivans, full-size vans, trucks, buses, commercial vehicles, recreational vehicles, and low-speed vehicles. Each vehicle 201 contains a device 100 that embodies the present invention, which displays charging information that is visible through a window to an external observer. The device 100 may be situated on a dashboard for a vehicle 201 with a charging port 202 in a rear quarter panel that is thus backed into the parking space or on a rear deck for a vehicle 201 with a charging port 202 in a front region that is thus parked forwards in the parking space, allowing the device 100 to face towards, and be viewable by, an EV driver approaching the charging location 200. Each vehicle 201 may include more than one instance of the device 100, increasing the directions from which the displayed information is visible. As will be described in greater detail with reference to FIGS. 4A-4F, each device 100, while its respective vehicle 201 is charging, displays the SOC percentage of the battery in numerical form, and at all other times of the charging session displays clearly decipherable charging status information using words. Since each device 100 connects to the on-board communication network of its respective vehicle 201, it is able to acquire and display this detailed charging information regardless of whether the connected charging station 203 is a DC or an AC charging station.

When another EV driver arrives at the charging location 200 wanting to use one of the charging stations 203 and approaches the vehicles 201, the driver can easily view the charging status and/or SOC of each vehicle 201 as displayed by each device 100 without having to exit their vehicle and without having to be in close proximity to the vehicles 201. Each device 100 displays the charging information in a format and at a large size that is viewable by an observer outside the vehicle 201 positioned at a distance of up to at least 25 feet. Clear and concise charging information displayed by each device 100 allows the approaching driver to immediately comprehend the status of each vehicle 201 without having to decode light indicators, wait for blinking light patterns to repeat, or count the number of small illuminated and unilluminated lights. Each device 100 shows either a precise SOC, which allows the approaching driver to better determine how close the respective vehicle 201 is to finishing its charging session, and therefore how soon the associated charging station 203 may be available, or shows the specific charging status, which allows the approaching driver to easily determine whether the associated charging station 203 is available for use and therefore if the respective vehicle 201 can be disconnected. Each device 100 displays said charging information for the entirety of the charging session, ensuring that the approaching driver is able to view the information regardless of when the driver arrives. Even if a vehicle 201 has stopped charging, finished charging, or has already been disconnected from the associated charging station 203 but not moved from the parking space, the respective device 100 remains active and displays the appropriate charging status of the vehicle 201.

With this detailed information the approaching driver can decide whether to park in an adjacent parking space 207 and wait for a vehicle 201 to finish charging or, if one of the vehicles 201 has finished charging, the driver may disconnect it and use the associated charging station 203 by connecting the respective charging cable 204 to their vehicle. If all of the vehicles 201 are actively charging and the respective devices 100 display low SOC numbers, thereby indicating that the vehicles 201 may not finish charging soon, the driver may decide to leave and try a different charging location or to return later. In some embodiments, the device 100 may display in numerical form, in addition to or in place of SOC, at least one of the charging time remaining and the instantaneous charging power while the respective vehicle 201 is actively charging. This information also helps the approaching driver determine how much longer the respective vehicle 201 may be charging.

If each vehicle 201 did not contain an embodiment of the present invention 100, the approaching EV driver would have to rely on the current state of EV charging indicators. In this common present scenario an approaching driver often must park their vehicle, exit their vehicle, approach the vehicles 201 on foot, determine where the charging indicators are located on those particular vehicles (for example a light in the charging port or a light on the dashboard), then try to deduce what the indicators mean if the indicators are even still active. As previously described, determining the charging status using these indicators can be difficult and imprecise, especially for vehicles with the simplest of charging indicator lights. The driver may also approach the charging stations 203 to view any screen or indicators that might exist on the units to see what charging information may be presented thereon. If the driver is able to determine the charging statuses of the vehicles 201 from any of these indicators, it may turn out that none of the charging stations 203 are available, nor are they likely to be in the near future, and so after all of these steps the driver may end up returning to their vehicle and departing, only to potentially repeat the same routine at another charging location. However, when each vehicle 201 contains an embodiment of the present invention 100, the approaching driver is able to reach the same determination immediately upon arrival, saving the driver time and effort.

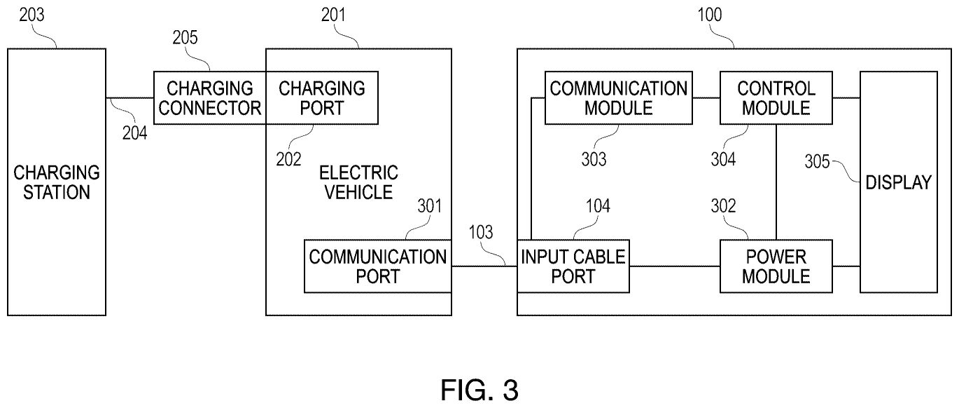

FIG. 3, with continued reference to FIGS. 1A-1F and FIG. 2, shows a block diagram of a device 100 that embodies the present invention, an electric vehicle 201, and a connected charging station 203. The vehicle 201 has a charging port 202 and is connected to the charging station 203 via the charging cable 204 and its terminating charging connector 205, which detachably connects to the charging port 202. The device 100 electrically connects to the vehicle 201 via an electrical cable 103. In embodiments where the device 100 is a self-contained vehicle accessory that is not permanently affixed to the vehicle 201, one end of the cable 103 detachably connects to the device 100 via the input cable port 104. The other end of the cable 103 may terminate in a standard OBD-II plug, or equivalent, to detachably connect to the on-board diagnostics and communication port 301 in the vehicle 201, or may terminate in another type of connecting means appropriate for detachably connecting to an on-board communication network of the vehicle 201 via the communication port 301. In embodiments wherein the device 100 is integral with the vehicle 201, the cable 103 may be a direct connection to the vehicle 201 and may not require the input cable port 104 and the communication port 301. Thus, the communication port 301 may represent an OBD-II port, another communication port, or a direct connection to one or more of the on-board communication networks.

The electrical cable 103 connects the device 100 to the on-board low voltage system of the vehicle 201 to provide electrical power for operation of the device 100, and connects the device 100 to at least one on-board communication network of the vehicle 201 to allow the device 100 to acquire vehicle and charging data from the vehicle 201.

The device 100 comprises a power module 302, a communication module 303, a control module 304, and a display 305. The power module 302 receives low-voltage vehicle power as input, may convert and regulate it as necessary, and supplies it to the other components, in particular the control module 304 and the display 305.

The control module 304 is composed of a microprocessor, associated circuits, and memory and it is programmed with one or more algorithms that, when executed, carry out the exemplary method 400, to be described in greater detail with reference to FIG. 4A. In some embodiments, the control module 304 is a module dedicated solely to the control of the device 100. In other embodiments, in particular wherein the device 100 is integral with the vehicle 201, the control module 304 may be part of a larger control module that controls multiple vehicle components or functions.

The communication module 303 connects to the on-board vehicle communication network. The on-board vehicle communication network may be a controller area network (CAN) bus, as is known, wherein numerous electronic control modules, sensors, and vehicle components communicatively connected to the CAN bus send and receive data that is carried throughout the entire vehicle system. The communication module 303, via its connection to the network and under control of the control module 304, may acquire, request, and receive data from one or more modules or components connected to the communication network.

The communication module 303 may transmit messages to request specific data from one or more modules or components on the communication network and may receive response messages containing said requested data. The communication module 303 may also monitor the messages traveling on the communication network between other modules or components and capture relevant data as necessary. The communication module 303 may also receive messages specifically directed to the control module 304 by one or more modules or components, sent via the communication network as a result of a changed condition, sensor signal, or updated data value controlled or monitored by the sending module or component.

Data collected by the communication module 303 is passed to the control module 304, which processes it and extracts the information needed to execute the exemplary method 400. Vehicle data acquired by the communication module 303 pertains to the status and operation of various vehicle components and may include charging status, charging connector connection status, charging port door status (open/closed/locked), high-voltage battery SOC, charging session data such as charging time remaining and instantaneous charging power, user-specified target charging SOC, and vehicle drive readiness status (whether the vehicle is off, powered to an accessory mode wherein some subsystems are active but the vehicle remains immovable, or powered on and either ready to drive or presently driving). Due to its direct access to the on-board vehicle communication network and all of the associated vehicle components, the device 100 is able to acquire detailed information about the vehicle 201, charging session, and charging process. This information is more extensive than what is available to the connected charging station 203, even a DC charging station, which, as previously described, has access to limited vehicle information via communication over the connected charging cable 204.

The control module 304, in carrying out the exemplary method 400, uses the acquired data to determine what information to show to an observer outside the vehicle 201 and instructs the display 305 to activate, if it is not already active, and to render the corresponding visual content. If the control module 304 determines that there is no content to show and that the display 305 should be inactive, it instructs the display 305 to deactivate, if it is presently active. In some embodiments, the display 305 may be a screen 102 that employs LCD, LED, digital, or any other display technology capable of rendering alphanumeric characters and graphical symbols. In other embodiments, the display 305 may employ a visual projecting means capable of displaying alphanumeric characters and graphical symbols on at least one window face, such that the information is visible from outside the vehicle 201.

In a further embodiment, the electrical cable 103 may carry only low-voltage power and may terminate in a standard 12-volt automotive accessory connector, USB connector, or other connecting means suitable for connecting to a low-voltage, in-vehicle power source. Connection between the communication module 303 and the on-board vehicle communication network may happen via wireless means, such as a Bluetooth connection, whereby the communication module 303 communicates with a separate wireless transceiver device that is connected to the vehicle communication port 301 and that wirelessly relays the messages between the communication module 303 and the on-board communication network. In a further embodiment, the device 100 may not use an electrical cable 103, thus having no direct electrical connection to the vehicle 201, and instead may contain an energy storage means such as a low-voltage battery that supplies power to the power module 302 and may contain one or more photovoltaic cells to recharge said battery and/or to supply power to the power module 302 when exposed to light. In a further embodiment, the internal battery may be recharged by connecting the device 100 to an appropriate external power source via the input cable port 104, or by inductive charging or other charging means known in the art.

Referring now to FIGS. 4A-4F, with continued reference to FIGS. 1A-3, FIG. 4A schematically illustrates a method 400 for controlling the device 100, in particular the visual content shown via the display 305. Embodiments of the present invention provide a method 400 in which, responsive to the charging status, charging connector connection status, and drive readiness status of the vehicle 201, SOC is displayed during charging and other charging statuses are displayed when the vehicle 201 is connected to the charging station 203 but not charging or after the vehicle 201 has charged but is disconnected from the charging station 203. The exemplary method 400 is represented by the five unique programmatic states (blocks 401, 402, 403, 404, and 405) in which the system may exist and the transitions between them, controlled by the control module 304 in response to the various events that may occur during a charging session. The control module 304 utilizes the previously described vehicle information obtained via the on-board communication network, including charging status, charging connector connection status, SOC, target charging SOC, and vehicle drive readiness status, to determine whether the system should remain in its current state or transition to a different one, and what information, if any, to show via the display 305. FIGS. 4B-4F illustrate the visual information shown via the display 305, wherein each distinct representation (visuals 411, 412, 413, 414, and 415) corresponds to a specific system state. These related numbered elements differ by a value of ten between a system state (e.g. 403) and its corresponding visual (e.g. 413).

The method 400 will now be described in detail. While the vehicle 201 is being driven or when it is stationary but before any attempts at charging are made, the system is in the “Standby” state 401 and the display 305 is inactive, represented by the Standby state visual 411, which shows no information. In embodiments that employ a retractable display, the display 305 is in the retracted, or inactive, position. The system remains in the Standby state 401 until an attempt at charging is made.

When a user first connects a parked vehicle 201 to a charging station 203 by attaching the charging connector 205 of the charging cable 204 to the vehicle charging port 202 (also referred to herein as “plugs in”), the control module 304 recognizes the change in charging connector connection status, acquires the SOC value, and determines whether charging is required. The display 305 is activated and, in embodiments that employ a retractable display, is deployed to its active position.

At this point, another piece of data that the control module 304 may acquire via the on-board vehicle communication network is the target charging SOC, also herein referred to as the “target SOC.” Most EVs have a default target SOC of 100%, wherein the vehicle will charge until the SOC of the battery reaches 100%. Some EVs provide an option that allows a user to specify (typically via an on-board human-machine interface such as an in-dash touchscreen or a remote interface such as a mobile application or website) if the vehicle battery will fully charge to 100% SOC or to choose an SOC below 100% at which the charging session will finish. There are various reasons a user may choose to enable such a feature, such as extending the longevity of the battery by minimizing degradation that may occur from repeated charges to 100% SOC or the user having knowledge that the trip immediately following the charging session may be substantially downhill and fully charging the battery before departing would prevent the vehicle from being able to capture and store in the battery, via regenerative braking, as much of the potential energy from the descent as possible. For those EVs without this user-customizable feature, or if the user has not set a custom value for the target SOC, the default target SOC is 100% or a full charge. The control module 304 thus acquires a user-specified target SOC value if it exists, or uses a default target SOC of 100% if it does not. Note that the battery SOC value referred to in discussion of the target SOC is the displayed SOC (the SOC value as presented to the driver such as via a dashboard gauge, as previously described) and not the true SOC of the battery.

The control module 304 compares the SOC and target SOC values to determine to which state to transition the system. (While the control module 304 may also have access to the true SOC value of the vehicle battery via the on-board communication network, that value does not factor into the charging session and is not acquired or used for comparison.) If the vehicle battery is already fully charged in the case of a default target SOC of 100%, or if the vehicle battery has an SOC that meets or exceeds a user-specified target SOC that is less than 100%, then charging does not begin and at step S401B the control module 304 transitions the system to the “Complete” state 405 and instructs the display 305 to show the Complete state visual 415. If the vehicle battery is not fully charged in the case of a default target SOC of 100%, or if the vehicle battery has an SOC that is below a user-specified target SOC that is less than 100%, then at step S401A the control module 304 transitions the system to the “Waiting” state 402 and instructs the display 305 to show the Waiting state visual 412.

In a typical scenario, the Waiting state 402 is short-lived and charging of the vehicle battery begins promptly. However, the system may remain in the Waiting state 402 for various reasons, all due to the fact that the charging process has not yet begun. This may be due to an issue with the vehicle 201, for example it may be in a powered-on state and may not allow charging until it is turned off, it may have a charging schedule that was set by the user and the present time is outside of the scheduled charging time period, or there may be a fault or other error with an on-board vehicle system such as the charging system. The charging station 203 also may not start charging the vehicle 201 because payment or other authorization may be required, it may have multiple charging cables but only charges one connected vehicle at a time and it is presently charging another connected vehicle, or there may be an issue with it such as a fault or other error with the equipment or activation of the charging session.

The advantages of the Waiting state 402 with the corresponding Waiting state visual 412 shown via the display 305 are evident when comparing to existing charging indicators that provide very limited information in this scenario. Before walking away from the connected vehicle 201, the driver may view the device 100 and if the Waiting state visual 412 is shown, the driver can clearly see that charging has not started and can take any necessary actions to address that, such as turning off the vehicle 201 or disabling a charging schedule. Sometimes this is expected, for instance when a driver must perform an action to activate the charging session, such as authorizing payment for the charging session or confirming that they have access to use the charging station 203 such as in a restricted workplace charging setting. Or in the case of a charging station 203 with multiple charging cables that charges connected vehicles sequentially, if another vehicle was already charging when the driver connected the vehicle 201 to a second charging connector and activated charging, the driver may leave the vehicle 201 knowing that charging will commence after the first vehicle has finished charging. When the driver of another EV approaches wanting to charge and sees the Waiting state visual 412 displayed by the device 100, the driver knows that the vehicle 201 has not even started its charging session yet so the associated charging station 203 will not be available until both the presently charging vehicle and the waiting vehicle 201 have finished their respective charging sessions. This driver also knows not to disconnect the vehicle 201 since its charging session has not yet started. Without the device 100 present to convey this information, a typical charging indicator on the vehicle 201 might look the same in this scenario as if charging had already proceeded and finished, implying that the charging cable 204 could be disconnected and causing confusion for an observer, who would then have to seek other means of determining whether the vehicle 201 is waiting to charge or is finished charging, such as walking up to and checking a screen on the charging station 203, which may not provide the desired information.

While in the Waiting state 402, if the driver of the vehicle 201 decides not to proceed with the charging session, for example the driver is unable to activate the charging station 203 or decides not to wait any longer for charging to start at a multi-cable charging station that is presently charging another vehicle, and the driver disconnects the charging connector 205 (also referred to herein as “unplugs”), then at step S402B the control module 304 recognizes the change in charging connector connection status and returns the system to the Standby state 401. The display 305 deactivates and, in embodiments that employ a retractable display, retracts to its inactive position. The vehicle 201 and the device 100 appear the same as they did before any attempts at charging were made.

Alternatively, while in the Waiting state 402, if charging begins, then at step S402A the control module 304 recognizes the change in vehicle charging status, transitions the system to the “Charging” state 403, and instructs the display 305 to show the Charging state visual 413. While the vehicle 201 is charging, the control module 304 continuously acquires the SOC of the battery and updates the Charging state visual 413 shown via the display 305 accordingly. The control module 304 may also continuously acquire other charging data such as instantaneous charging power or time remaining in the charging session, which in some embodiments may be shown via the display 305. By displaying the exact numerical SOC value to an observer outside of the vehicle 201, the device 100 is an improvement over the ambiguity and imprecision of existing charging indicators because the number is immediately understandable and the precision allows the observer to better determine how close the vehicle 201 is to finishing its charging session. The display 305 remains active and shows the Charging state visual 413 for the entire time the vehicle 201 is charging. The Charging state 403 may also be a benefit to the driver. If the driver of the vehicle 201 returns to the vicinity of the vehicle 201 to check on the charging session and observes the Charging state visual 413 shown via the display 305, the driver immediately knows the exact SOC. If the driver wants to leave or stop charging at a certain SOC instead of waiting for a full charge, especially if the driver did not set or was unable to set a target SOC, and the driver sees that the SOC has met or exceeded the desired level, they can disconnect the charging cable 204 and depart the charging location 200 or at least move the vehicle 201 from the charging station parking spot to another parking spot that does not have a charging station.

In typical conditions, the system remains in the Charging state 403 for the majority of the time the device 100 is active. While in the Charging state 403, charging of the vehicle battery may stop before the charging session is complete (i.e. before the battery is fully charged or before it reaches a user-specified target SOC that is less than 100%). This may happen for various reasons, such as disconnection of the charging connector 205 or the charging station 203 ceasing power delivery due to expiration of a charging station charging time limit, power loss, a charging station error, or a vehicle error. At step S403A, when charging stops before the charging session is complete, the control module 304 recognizes the change in vehicle charging status, evaluates the SOC to confirm that the stoppage was not due to the SOC reaching 100% or a user-specified target SOC that is less than 100%, and then transitions the system to the “Stopped” state 404 and instructs the display 305 to show the Stopped state visual 414.

Alternatively, while in the Charging state 403, if the charging session finishes normally (i.e. the battery is fully charged, reaching an SOC of 100%, or reaches a user-specified target SOC that is less than 100%), then at step S403B the control module 304 recognizes the change in vehicle charging status, evaluates the SOC to confirm that the stoppage was due to the SOC reaching 100% or a user-specified target SOC that is less than 100%, and then transitions the system to the Complete state 405 and instructs the display 305 to show the Complete state visual 415. Thus, if the SOC is less than 100% when charging stops, by comparing the SOC to a user-specified target SOC that may exist, the control module 304 can correctly determine, and then instruct the display 305 to show, whether charging is complete or whether it stopped early. Since the user may have set or changed the target SOC value during the charging session, the control module 304 may reacquire the target SOC value before comparing it to the SOC value when charging stopped.

The advantages of the Stopped state 404 with the corresponding Stopped state visual 414 shown via the display 305 are evident when comparing to existing charging indicators that provide very limited information in this scenario. An indication of a charging stoppage, if any, provided by these existing indicators is typically based on a color and/or illumination behavior of one or more lights and typically remains active for only a few minutes, leaving an observer with either unclear information for the first few minutes after the stoppage or, if the observer arrives after that short time period, no information about the charging status. An observer then must attempt to consult the associated charging station, but the charging station may not provide adequate information. For example, some AC charging stations may show a message on a screen that a connected vehicle is not charging. However, since an AC charging station does not have access to the SOC or other detailed information from the vehicle, regardless of what the message claims, the charging station cannot specify with certainty whether there was a charging interruption or whether charging is complete. In some instances, a charging station may have limited or no indicators on it, so even if it is a DC charging station, which has access to the SOC, it may not provide clarity about the vehicle charging status to an observer.

With the device 100 present in the vehicle 201, on the other hand, the display 305 remains active while in the Stopped state 404 and the Stopped state visual 414 makes the charging status of the vehicle 201 unambiguous to an external observer by making an explicit distinction that this is an interrupted charging session and not a completed charging session. The device 100 thereby informs the observer that the vehicle 201 is not actually finished charging and that the charging station 203 is not available for use, as well as the possibility that there may be an issue with the charging station 203 that caused the stoppage and thus may prevent charging of the observer's vehicle if the observer were to disconnect the charging cable 204 and attempt to charge their vehicle. The Stopped state 404 may also be a benefit to the driver of the vehicle 201. If the driver returns to the vicinity of the vehicle 201 to check on the charging session and unexpectedly observes the Stopped state visual 414 shown via the display 305, then the driver immediately knows to take any necessary actions to try to resume the charging session.

While in the Stopped state 404, various occurrences result in no change to the system, as shown by step S404C, wherein there is no transition to a different state. These occurrences include a user reconnecting the charging connector 205 that may have been disconnected, a user disconnecting the charging connector 205 where the cause of stoppage had been something other than such a disconnection for example the charging station 203 ceasing power delivery, and the driver turning on the vehicle 201 to its accessory mode. If a disconnected charging connector 205 that had been the cause of the stoppage is reconnected, the system may not remain in the Stopped state 404 for long as shortly thereafter the charging session may resume. If the charging station 203 ceasing power delivery had been the cause of the stoppage and it recovers, for example due to its power supply being restored or the resolution of an error that may have existed, the charging session may also resume. In these and other cases wherein charging resumes while in the Stopped state 404, at step S404B the control module 304 recognizes the change in vehicle charging status, transitions the system back to the Charging state 403, and instructs the display 305 to show the Charging state visual 413.

Alternatively, while in the Stopped state 404, if the charging connector 205 had previously been disconnected from the vehicle 201, whether or not that had been the cause of the charging session stoppage, the driver may now turn on the vehicle 201 to its drive ready mode in preparation for departing the charging location 200. These actions may be a quick sequence of events wherein a driver returns to the vehicle 201 before charging is complete, disconnects the charging connector 205 from the charging port 202, enters the vehicle 201, turns it on, and drives away. (In this case, the cause of stoppage had been disconnection of the charging connector 205 and it had been intentional, but that does not need to be the case.) Or, the disconnection and subsequent entrance to drive ready mode events may occur at any point after charging stops. At step S404A, once the vehicle 201 enters drive ready mode, the control module 304 recognizes the change in vehicle drive readiness status and transitions the system to the Standby state 401. The display 305 deactivates and, in embodiments that employ a retractable display, retracts to its inactive position.

The advantages of the Complete state 405 with the corresponding Complete state visual 415 shown via the display 305 are evident when comparing to existing charging indicators that provide very limited information in this scenario. An indication of a completed charging session, if any, provided by these existing indicators is typically based on a color and/or illumination behavior of one or more lights and typically remains active for only a few minutes, leaving an observer with either unclear information for the first few minutes after the completed charging session or, if the observer arrives after that short time period, no information about the charging status. An observer then must attempt to consult the associated charging station, but the charging station may not provide adequate information, as previously described in discussion of the Stopped state 404.

With the device 100 present in the vehicle 201, on the other hand, the display 305 remains active while in the Complete state 405 and the Complete state visual 415 makes the charging status of the vehicle 201 unambiguous to an external observer by making an explicit distinction that this is a completed charging session and not an interrupted charging session. The device 100 thereby informs the observer that the vehicle 201 is finished charging and that the charging station 203 is available for use. The Complete state 405 may also be a benefit to the driver of the vehicle 201. If the driver returns to the vicinity of the vehicle 201 to check on the charging session and observes the Complete state visual 415 shown via the display 305, then the driver immediately knows that the charging session is complete and that they can disconnect the charging cable 204 and depart the charging location 200 or at least move the vehicle 201 from the charging station parking spot to another parking spot that does not have a charging station.

During a charging session a user may be inside the vehicle 201 using accessory loads such as the climate control, powered by energy from the vehicle battery. When the charging session has finished, and the system is in the Complete state 405, if enough of the energy stored in the battery is used by accessories while the vehicle 201 is still connected to the charging station 203, charging may restart. At step S405B the control module 304 recognizes the change in vehicle charging status, transitions the system back to the Charging state 403, and instructs the display 305 to show the Charging state visual 413.

While in the Complete state 405, various occurrences result in no change to the system, as shown by step S405C, wherein there is no transition to a different state. These occurrences include a user disconnecting the charging connector 205, a user reconnecting the charging connector 205 that may have been disconnected, and the driver turning on the vehicle 201 to its accessory mode.

While in the Complete state 405, if the charging connector 205 had previously been disconnected from the vehicle 201, the driver may now turn on the vehicle 201 to its drive ready mode in preparation for departing the charging location 200. This may occur at any point after charging finishes. At step S405A, once the vehicle 201 enters drive ready mode, the control module 304 recognizes the change in vehicle drive readiness status and transitions the system to the Standby state 401. The display 305 deactivates and, in embodiments that employ a retractable display, retracts to its inactive position.

After disconnection of a charging cable from an EV, existing vehicle charging indicators deactivate and any information presented via a screen or indicators on the charging station resets, leaving an observer with no information about the charging status of the disconnected vehicle. If a vehicle is disconnected and not moved, for example if it is disconnected by someone who is not the driver of the vehicle, the lack of information about the vehicle's charging status is problematic for any subsequent EV driver who arrives at the charging location wanting to charge their vehicle, creating confusion about whether the parked vehicle is waiting to charge, has already charged, or had an issue while charging.

With the device 100 present in the vehicle 201, on the other hand, the display 305 continues to provide charging status and/or SOC information to an observer even after the charging connector 205 is disconnected from the charging port 202. While in the Stopped state 404 or the Complete state 405, if the charging connector 205 has been disconnected from the vehicle 201, the display 305 still remains active and continues to show the Stopped state visual 414 or the Complete state visual 415, respectively. This informs an arriving driver in another vehicle who wants to charge, and who arrives after the disconnection event, of the charging status of the vehicle 201. The device 100 thus informs the arriving driver that the vehicle 201 is not waiting to start a charging session but rather it had been charging previously and, depending on whether the display 305 is showing the Stopped state visual 414 or the Complete state visual 415, that charging was interrupted or is now finished, respectively. With this information, the arriving driver can make a decision about whether they can charge their vehicle with the associated charging station 203.

If the display 305 shows the Stopped state visual 414, and therefore the system is in the Stopped state 404, the second driver could reconnect the charging cable 204 to the vehicle 201 to see if charging resumes. Charging may resume if there are no issues with the vehicle 201 or the charging station 203 and if the charging station 203 either does not require payment and/or manual activation or if the vehicle 201 and the charging station 203 are capable of an automatic authentication and activation process such as the “Plug & Charge” feature of ISO 15118. Charging may not resume if there had been a problem with the vehicle 201 or the charging station 203, or if additional activation is required at the charging station 203. If charging does not resume, the second driver may try to activate the charging station 203 on behalf of the other driver or may try to charge their own vehicle, aware that an issue may be present with the charging station 203.

If the display 305 instead shows the Complete state visual 415, and therefore the system is in the Complete state 405, the second driver may connect the charging cable 204 to their own vehicle to begin a charging session, knowing that the vehicle 201 is finished using the charging station 203, and even though the charging cable 204 had already been disconnected, the driver merely has not yet returned to move the charged vehicle 201.

In another similar scenario, if a driver returns to their vehicle connected to the charging station 203 with the intention of departing and observes a vehicle 201 equipped with the device 100 parked in an adjacent parking space, and with a charging port 202 that is reachable by the charging cable 204 of the charging station 203 to which this driver's vehicle is connected, the departing driver may view any visual shown by the display 305 and know whether or not to connect the charging cable 204 to the vehicle 201 after disconnecting it from their vehicle. If the display 305 is showing the Complete state visual 415, the departing driver immediately knows that the vehicle 201 has already successfully charged, is not waiting for the charging station 203, and does not need to be connected to it. The departing driver can leave the charging station 203 idle, ready for the next driver who arrives. If the charged vehicle 201 continues to remain parked there, when the next arriving EV driver approaches they will know from viewing the display 305 that the vehicle 201 does not need to be charged and the charging station 203 is available for use. If the display 305 is instead showing the Stopped state visual 414 or no visual at all (i.e. the Standby state visual 411), the departing driver knows that the vehicle 201 either had been charging but was interrupted and disconnected or had not been charging and is waiting to use the charging station 203. The departing driver therefore may attempt to help the driver of the vehicle 201 and try to restart, or start for the first time, the charging session before leaving by connecting the charging cable 204 to the charging port 202 of the vehicle 201. The charging session may or may not begin depending on various factors, as described previously.

Note that, at steps S404C and S405C, the lists of events described herein and shown in FIG. 4A that result in the system remaining in its present state, the Stopped state 404 or the Complete state 405 respectively, are merely those events that are most likely to occur. The lists are not exhaustive and additional actions and events not described herein but that occur while the system is in one of these two states will also result in the system remaining in its present state. Only the events explicitly described as causing an exit from the Stopped state 404 at steps S404A and S404B, or an exit from the Complete state 405 at steps S405A and S405B, will result in a change to the system state when the system is in one of these two states.

Note also that, for safety purposes, every EV is configured such that it cannot enter drive ready mode with a charging connector connected to the vehicle charging port. Hence, the charging connector 205 must first be disconnected from the vehicle 201 at step S402B, S403A, S404C, or S405C before the vehicle 201 can enter drive ready mode. Any attempt by a driver to turn on the vehicle 201 while the charging connector 205 is connected to the charging port 202, regardless of the vehicle charging status, results in the vehicle 201 entering accessory mode, wherein various subsystems such as the climate control, lights, and stereo may be active but the vehicle 201 is not drivable. This scenario may arise if a driver or passenger has chosen to remain in the vehicle 201 while it is charging. Although it is typical that the vehicle 201 is off during a charging session, the charging session proceeds unaffected by whether the vehicle 201 is off or in accessory mode.

Similarly, the method 400 proceeds as illustrated in FIG. 4A whether the vehicle 201 is off or in accessory mode. For simplicity, the vehicle 201 entering accessory mode is not shown for every state. At any state, the vehicle 201 may be off or in accessory mode, or may change between the two modes, and this does not result in the system exiting its present state. However, the vehicle 201 entering accessory mode is described and shown for the Stopped state 404 at step S404C and the Complete state 405 at step S405C to highlight the distinction between how the control module 304 responds when the vehicle 201 enters accessory mode and when the vehicle 201 enters drive ready mode. While in one of these two states, if the vehicle 201 enters accessory mode, then at step S404C or S405C the control module 304 continues to instruct the display 305 to remain active and to show the same visual content that it had been showing. If the vehicle 201 enters drive ready mode, however, then at step S404A or S405A the control module 304 deactivates the display 305 and transitions the system to the Standby state 401. Since the vehicle 201 cannot enter drive ready mode when the charging connector 205 is connected to the charging port 202, notation of the vehicle 201 entering accessory mode is omitted from the illustration at the Waiting state 402 and the Charging state 403.

In a further embodiment, the method 400 includes an additional check (illustration omitted) to determine if the user has set a location-based preference that the device 100 remain inactive at the present charging location 200. When the system is in the Standby state 401 and the vehicle 201 is first connected to the charging station 203, the control module 304 recognizes the change in charging connector connection status, acquires the present GPS location of the vehicle 201 via the on-board vehicle communication network, and compares that with a stored list of charging locations that the user may have set via an in-vehicle or on-device settings menu, locations at which the user has specified that the device 100 should be inactive. If the present charging location 200 is one of the locations on the stored list, the control module 304 keeps the system in the Standby state 401 and does not activate the display 305. If the present charging location 200 is not one of the locations on the stored list, the control module 304 proceeds with the method 400 as previously described.

In a further embodiment, the method 400 relies on the opening of a charging port door 206 as the event that triggers a transition of the system out of the Standby state 401, instead of the connection of a charging connector 205. Thus, when a user first opens a charging port door 206 of a parked electric vehicle 201 that contains the device 100, the control module 304 recognizes the change in the charging port door status and then acquires and compares the SOC and target SOC values to determine whether to transition the system to the Waiting state 402 or the Complete state 405. This allows an EV driver who arrives at a charging location 200 where each charging station 203 is presently in use, to park in an adjacent parking space 207, open the charging port door 206, and with the display 305 showing the Waiting state visual 412 while the system is in the Waiting state 402, thereby convey to other EV drivers that they are awaiting use of a charging station 203 and for the next available charging station 203 to be connected, if possible, if the driver is not present. While in the Waiting state 402, connecting or disconnecting a charging connector 205 results in no change to the system state. While in the Waiting state 402, if there is no charging connector 205 connected to the charging port 202 and a user closes the charging port door 206, the control module 304 recognizes the change in the charging port door status and returns the system to the Standby state 401. Alternatively, if charging begins after a user connects a charging connector 205, the method 400 proceeds as previously described. While in either the Stopped state 404 or the Complete state 405 with no charging connector 205 connected, closing of the charging port door 206 results in no change to the system state.

The configuration of the visual information shown via the display 305 will now be described in greater detail. As illustrated in FIGS. 4B-4F, the visual information shown via the display 305 comprises a customizable content region with either a first area 416 encompassing the entire display region that may show words (e.g. the phrases 416A, 416B, and 416C) or a first area 416 encompassing the entire display region that contains a combination of two adjacent smaller areas: a second area 417 that may show an animated graphic 417A indicating active charging and a third area 418 that may show vehicle charging data such as the numerical SOC percentage 418A. Displayed content is configured for maximum visibility, utilizing large, sharp characters and symbols in a high contrast combination of white or light-color content on a black background, such that the information is viewable by an observer outside the vehicle 201 positioned at a distance of up to at least 25 feet.

The Standby state visual 411 consists of no content since the display 305 is inactive during the Standby state 401. Word-based messages 416A, 416B, and 416C are displayed statically and they concisely and clearly convey the charging status of the vehicle 201 to an external observer. The Waiting state visual 412 consists of a Waiting message 416A, which is shown during the Waiting state 402. The Stopped state visual 414 consists of a Stopped message 416B, which is shown during the Stopped state 404. The Complete state visual 415 consists of a Complete message 416C, which is shown during the Complete state 405. The phrases depicted are representative and may include other variations that also concisely and clearly convey the charging status or other charging information. The words are depicted in English but may be displayed in any language appropriate for the region where the device 100 is in use. If a specific message is too long to show in its entirety at one time, the control module 304 may instruct the display 305 to scroll the message horizontally or vertically, to show the message word by word, or otherwise to switch the content in order to convey the entire message.

The Charging state visual 413 consists of a charging animation graphic 417A and the vehicle battery SOC 418A, which are shown during the Charging state 403. While in the Charging state 403, the control module 304 continuously instructs the display 305 to update the numerical value of the SOC 418A as the amount of energy stored in the vehicle battery increases. A charging animation graphic 417A, such as the stylized lightning bolt pictured, may be green in color and pulse continuously (increasing its brightness from invisible to full brightness, decreasing back to invisible, and then repeating the process, with the duration of one cycle being several seconds) to convey that the vehicle 201 is presently charging. Other graphics or symbols such as a plug or a battery, and other animation sequences such as blinking, rotating, and horizontal, vertical, or diagonal movements, may be utilized.

In a further embodiment, the word-based messages displayed during the Waiting state 402, the Stopped state 404, and the Complete state 405 may be shown alongside one or more graphical symbols. Instead of a message appearing in the first area 416 and encompassing the entire display area, the message may appear in the third area 418 and a relevant graphical symbol may appear simultaneously in the second area 417. The graphic may be static or animated, employing any of the aforementioned animation techniques, and may be shown in a bright color to add visual emphasis.

In a further embodiment, when in the Waiting state 402, the control module 304 may determine the reason why charging has not started by assessing additional data acquired from the vehicle 201 via the on-board communication network. Instead of the Waiting state visual 412 with the Waiting message 416A, the control module 304 may instruct the display 305 to show a concise message describing the reason that charging has not started, such as “Schedule Set” if there is a charging schedule set and the time is not presently within the scheduled time period or “Station Off” if the charging station 203 has no power. The control module 304 may also instruct the display 305 to alternate slowly and repeatedly, for example every five to ten seconds, between showing the Waiting message 416A and showing this more detailed message.

In a further embodiment, when in the Charging state 403, the control module 304 may instruct the display 305 to show a word-based description of the charging status such as “Charging.” This may be shown instead of, or in addition to, the charging animation graphic 417A. Therefore the display 305 may alternate slowly and repeatedly, for example every five to ten seconds, between showing this new message and showing the SOC 418A or between showing this new message and showing the combination of the charging animation graphic 417A and the SOC 418A.

In a further embodiment, when in the Charging state 403, the control module 304 may also continuously acquire other charging data besides the SOC, such as the instantaneous charging power and the time remaining in the charging session, via the on-board communication network. The control module 304 may instruct the display 305 to show as a precise numerical value the charging power (e.g. “121 kW”) and/or the time remaining (e.g. “1:30” or “1 h 30 m”) in addition to or in place of the SOC 418A. The time remaining may be the time remaining until the charging session is finished or it may be the time remaining until the driver will depart the charging location 200, as entered manually by the driver via an in-vehicle or on-device settings menu at the start of the charging session.

In a further embodiment, when in the Stopped state 404, the control module 304 may instruct the display 305 to alternate slowly and repeatedly, for example every five to ten seconds, between showing the Stopped message 416B and showing the SOC 418A, which conveys the SOC of the vehicle 201 when the charging session stopped. This not only informs an external observer that the charging session was interrupted but also conveys how close the vehicle 201 was to finishing its charging session, and therefore how much longer the vehicle 201 may occupy the charging station 203 if the charging session were to resume. In a further embodiment, instead of the SOC 418A, the value shown may be the time remaining when the charging session stopped.

In a further embodiment, when in the Stopped state 404, the control module 304 may determine the reason why charging stopped by assessing additional data acquired from the vehicle 201 via the on-board communication network. The control module 304 may instruct the display 305 to show a concise message describing the reason that charging stopped, such as “Cable Unplugged” if the charging cable 204 had been disconnected or “Station Error” if the charging station 203 experienced an error. The control module 304 may also instruct the display 305 to alternate slowly and repeatedly, for example every five to ten seconds, between showing the Stopped message 416B and showing this more detailed message.

In a further embodiment, when in the Complete state 405, if the charging session finished due to the SOC reaching a user-specified target SOC less than 100%, the control module 304 may instruct the display 305 to alternate slowly and repeatedly, for example every five to ten seconds, between showing the Complete message 416C and showing the SOC 418A, which conveys the final SOC of the vehicle 201 when the charging session finished.

Reference herein to “an embodiment,” “one embodiment,” or similar language means that a specific feature, element, structure, or characteristic described in connection with the embodiment is included in at least one embodiment of the present invention. Appearances of the phrases “in an embodiment,” “in one embodiment,” and similar language throughout this specification are not necessarily all referring to the same embodiment. Furthermore, separate or alternative embodiments are not necessarily mutually exclusive of other embodiments. Features of various embodiments also may be combined to form further embodiments of the present invention.

The word “exemplary” as used herein denotes that which serves as an example, instance, or illustration. Any aspect or design described as “exemplary” is not necessarily to be construed as preferred over other aspects or designs. Instead, use of the word “exemplary” is meant to show concepts in a concrete manner.

As used herein, the terms “including,” “comprising,” or similar phrases and the variations thereof mean “including but not limited to” unless specified otherwise. A listing of items does not imply that any or all of the items are mutually exclusive and/or mutually inclusive, unless specified otherwise. The term “or” is intended to mean an inclusive “or” rather than an exclusive “or” unless specified otherwise. The terms “a,” “an,” and “the” refer to “one or more” unless specified otherwise or clear from context to be intended as the singular form.

While embodiments of the present invention are illustrated and described herein, it is not intended that these embodiments illustrate and describe all possible forms of the present invention. The words used are ones of description rather than limitation and various changes and modifications may be made without departing from the spirit and scope of the present invention.

While certain novel features of the present invention have been shown and described, it will be understood that various omissions, substitutions and changes in the forms and details of the device illustrated and in its operation can be made by those skilled in the art without departing from the spirit of the invention.

I claim:

1. An electric vehicle charge status display system comprising:
a display;
a data connection to the electric vehicle, the data connection conveying:
at least one of the following status indications: ready to charge, charging in progress, connected, disconnected, charging interrupted, waiting, and charging complete; and
at least one of the following information items: electric vehicle charge level, rate of charge to the electric vehicle, time left in charging session, state of charging session,
where the display projects at least one of the status indications and at least one of the information items.

2. The electric vehicle charge status display system of claim 1, further comprising:
a support bracket capable of moving the display from a stored position to an active position.

3. The electric vehicle charge status display system of claim 2, further comprising:
a storage location in the electric vehicle capable of holding the display in the stored position.

4. The electric vehicle charge status display system of claim 2, further comprising:
a motor capable of moving the display from a stored position to an active position.

5. The electric vehicle charge status display system of claim 1, further comprising:
a wireless transmitter transmitting the same data as projected by the display.

6. The electric vehicle charge status display system of claim 1, further comprising:
mounting hardware allowing for a user to position the display in a desired location.

7. The electric vehicle charge status display system of claim 1, where the data connection is a connection to a data port of the electric vehicle.

8. The electric vehicle charge status display system of claim 1, where the display projects at least one of the status indications and at least one of the information items in a manner that can be discernible at a distance of at least 25 feet.

9. The electric vehicle charge status display system of claim 1, further comprising:
a wireless transmitter transmitting at least one of the status indications and at least one of the information items.

10. A method for charging an electric vehicle comprising the steps of:
recognizing a connection from an external charging system to a charge port of the electric vehicle;
acquiring a current vehicle state of charge from the electric vehicle;
activating a display in the electric vehicle;
acquiring a target charge level from the electric vehicle;
comparing the current vehicle state of charge with the target charge level, and if the current vehicle state of charge equals the target charge level, display completion of charging session;
detecting a start of a charging session, and if a charging session is not started, put system into waiting status;
checking the connection between the electric vehicle charge port and the external charging system, and evaluating if the connection is disconnected or terminated, whereafter displaying a stopped status;
detecting if a charging session begins, and then repeating the following steps:
acquiring a current vehicle state of charge;
comparing the current vehicle state of charge with a target charge level;
calculating time to reach target charge level based on a current rate of charge and the vehicle state of charge;
displaying a “charging” state;
displaying a state of the charging session, where the state of the charging session can be seen outside of the electric vehicle;
detecting if a charging session stops, and if the stopping of the charging session is planned, display “complete” status, otherwise if the stopping of the charging session is unplanned or interrupted, display “stopped” status.

11. The method of claim 10, where the display is active from the initial activation step until the electric vehicle leaves the external charging station.

12. The method of claim 10, further comprising:
deactivating the display if the external charging system is disconnected from the electric vehicle charge port.

13. The method of claim 10, further comprising:
moving the deactivated display into a storage compartment within the electric vehicle.

14. The method of claim 10, where all displayed information is visible from a distance at least 25 feet from the electric vehicle.

15. The method of claim 10, further comprising:
transmitting the displayed information via a wireless transmission protocol.

16. The method of claim 10, where the target charge level is acquired from one of the electric vehicle or an operator of the electric vehicle.

17. The method of claim 10, where recognizing a connection from an external charging system to a charge port of the electric vehicle comprises opening a charge port door on the electric vehicle.

18. The method of claim 10, where recognizing a connection from an external charging system to a charge port of the electric vehicle comprises the alignment of a vehicle receiving coil and an external charging system transmitting coil for inductive charging

19. A method for charging an electric vehicle comprising the steps of:
recognizing if a charging session has started;
acquiring a current vehicle state of charge from the electric vehicle;
activating a display;
acquiring a current rate of charge for the charging session;
acquiring a target charge level from one of the electric vehicle or an operator of the electric vehicle;
comparing the current vehicle state of charge with the target charge level;
calculating the time to reach the target charge level based on the current rate of charge and vehicle state of charge; and
displaying a status of the charging session and at least one of time to target charge level and current vehicle state of charge;
where if the calculated time to reach target charge level is zero, display completion of charging session.

20. The method of claim 19, further comprising:
repeatedly acquiring the current rate of charge and current vehicle state of charge; and
recalculating the time to reach the target charge level.
